(19) United States
(12) Patent Application Publication
(10) Pub. No.: US 2014/0036718 A1
(43) Pub. Date: Feb. 6, 2014

(54) DEVICE TO DEVICE CLUSTER ENHANCEMENT TO SUPPORT DATA TRANSMISSION FROM/TO MULTIPLE DEVICES

(71) Applicants: Chunyan Gao, Beijing (CN); Haiming Wang, Beijing (CN); Gilles Charbit, Hampshire (GB)

(72) Inventors: Chunyan Gao, Beijing (CN); Haiming Wang, Beijing (CN); Gilles Charbit, Hampshire (GB)

(73) Assignee: NOKIA CORPORATION, Espoo (FI)

(21) Appl. No.: 13/884,665

(22) PCT Filed: Dec. 3, 2010
(86) PCT No.: PCT/CN2010/001961

§ 371 Date: Jun. 21, 2013

(51) Int. Cl. H04W 84/20

(52) U.S. Cl. CPC H04W 84/20
USPC 370/254

(57) ABSTRACT

The exemplary embodiments of this invention provide, in one aspect thereof, a method that includes operating a first wireless communications device in a role as a cluster head in a device-to-device communication mode cluster; and autonomously transferring the role of the cluster head to a second wireless communications device in the device-to-device communication mode cluster. In this method only a wireless communications device that is operating in the role of the cluster head has authority to transmit new data to another wireless communications device in the device-to-device communication mode cluster. The exemplary embodiments of this invention also provide, in another aspect thereof, a method that includes operating a first wireless communications device in a role as a cluster head in a device-to-device communication mode cluster; and transmitting a scheduling grant from the wireless communications device that is operating in the role of the cluster head to another wireless communications device in the device-to-device communication mode cluster, In this method the scheduling grant authorizes the another wireless communications device to perform, during a subframe specified by first information in the scheduling grant, a retransmission of data that was received by the another wireless communications device during a subframe specified by second information in the scheduling grant. Also disclosed are corresponding apparatus and computer readable memories storing computer program instructions to implement the methods.

### TECHNICAL FIELD

The exemplary and non-limiting embodiments of this invention relate generally to wireless communication systems, methods, devices and computer programs and, more specifically, relate to mobile wireless communication nodes and devices capable of directly communicating with one another, and to their operation with a wireless network access node.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
ACK acknowledgment
BS base station
D2D device-to-device
DCI downlink control information
DL downlink (eNB towards UE)
DRX discontinuous reception
eNB E-UTRAN Node B (evolved Node B)
EPC evolved packet core
E-UTRAN evolved UTRAN (LTE)
FDD frequency division duplex
FDM frequency division multiplex
HARQ hybrid autonomous retransmission request
IMTA international mobile telecommunications association
ITU-R international telecommunication union-radiocommunication sector
LTE long term evolution of UTRAN (E-UTRAN)
LTE-A LTE advanced
MAC medium access control (layer 2, L2)
MM/MME mobility management/mobility management entity
NACK negative acknowledgment
NodeB base station
OFDM orthogonal frequency division multiplex
O&M operations and maintenance
PDCP packet data convergence protocol
PHY physical (layer 1, L1)
Rel release
RLC radio link control
RNTI radio network temporary identifier
RRC radio resource control
RRM radio resource management
RTT round trip time
SGW serving gateway
SC-FDMA single carrier, frequency division multiple access
TDD time division duplex
TDM time division multiplex
TPC transmission power control
UE user equipment, such as a mobile station, mobile node or mobile terminal
UL uplink (UE towards eNB)
UPE user plane entity
UTRAN universal terrestrial radio access network

One modern communication system is known as evolved UTRAN (E-UTRAN, also referred to as UTRAN-LTE or as E-UTRA). In this system the DL access technique is OFDMA, and the UL access technique is SC-FDMA.

One specification of interest is 3GPP TS 36.300, V8.11.0 (2009-12), 3rd Generation Partnership Project; Technical Specification Group Radio Access Network; Evolved Universal Terrestrial Radio Access (E-UTRA) and Evolved Universal Terrestrial Access Network (EUTRAN); Overall description; Stage 2 (Release 8), incorporated by reference herein in its entirety. This system may be referred to for convenience as LTE Rel-8. In general, the set of specifications given generally as 3GPP TS 36.xyz (e.g., 36.211, 36.311, 36.312, etc.) may be seen as describing the Release 8 LTE system. More recently, Release 9 versions of at least some of these specifications have been published including 3GPP TS 36.300, V9.3.0 (2010-03).

FIG. 1 reproduces FIG. 4.1 of 3GPP TS 36.300 V8.11.0, and shows the overall architecture of the EUTRAN system (Rel-8). The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of a S1 MME interface and to a S-GW by means of a S1 interface (MME/S-GW 4). The S1 interface supports a many-to-many relationship between MMEs/S-GWs/UPEs and eNBs.

The eNB hosts the following functions:
functions for RRM: RRC, Radio Admission Control, Connection Mobility Control, Dynamic allocation of resources to UEs in both UL and DL (scheduling);
IP header compression and encryption of the user data stream;
selection of a MME at UE attachment;
routing of User Plane data towards the EPC (MME/S-GW);
scheduling and transmission of paging messages (originated from the MME);
scheduling and transmission of broadcast information (originated from the MME or O&M); and
a measurement and measurement reporting configuration for mobility and scheduling.

Of particular interest herein are the further releases of 3GPP LTE (e.g., LTE Rel-10 and beyond Rel-10) targeted towards future IMTA systems, referred to herein for convenience simply as LTE-Advanced (LTE-A). Reference in this regard may be made to 3GPP TR 36.913, V9.0.0 (2009-12), 3rd Generation Partnership Project; Technical Specification Group Radio Access Network; Requirements for Further Advancements for E-UTRA (LTE-Advanced) (Release 9). Reference can also be made to 3GPP TR 36.912 V9.2.0 (2010-03) Technical Report 3rd Generation Partnership Project; Technical Specification Group Radio Access Network; Feasibility study for Further Advancements for E-UTRA (LTE-Advanced) (Release 9).

A goal of LTE-A is to provide significantly enhanced services by means of higher data rates and lower latency with reduced cost. LTE-A is directed toward extending and optimizing the 3GPP LTE Rel-8 radio access technologies to provide higher data rates at lower cost. LTE-A will be a more optimized radio system fulfilling the ITU-R requirements for IMT-Advanced while keeping the backward compatibility with LTE Rel-8.

Device to Device (D2D) communication is attracting significant interest for at least the following reasons:
it is seen as a potential technique for improve local area coverage;
it is seen as a potential solution to improve resource efficiency;
it can aid in conserving both UE and eNB transmit (Tx) power;
it can aid in reducing the load on the cellular network; and
it has the potential to provide new types of services for end users.

Data transfer has been recognized as a promising one of the many potential use cases of D2D. The D2D data transfer can occur between two devices, from one device to multiple devices, or using multiple transmitters and multiple receivers. When integrating the D2D data transfer into cellular systems there are various implementation approaches. These approaches can mainly be classified into two categories: autonomous D2D and eNB-controlled in-band D2D. Due to the advantages of high QoS, high resource efficiency and more controllability by network operators, the eNB-controlled in-band D2D approach is currently being pursued with a higher priority than the autonomous D2D for standardization in the near term (e.g., LTE Rel-11, LTE Rel-12). The autonomous D2D is currently seen as a longer-term development.

For eNB controlled in-band D2D, to enable data transfer among multiple devices, the concept of a cluster has been proposed. In the proposed D2D cluster the eNB allocates resources to a cluster head, and all subsequent communication within the cluster is controlled by the cluster head. This control includes resource allocation for data transfer from transmitters, resource allocation for feedback from receivers, scheduling and link adaptation. In a case where there are multiple transmitters each with different target receivers, where each receiver may need to receive from multiple transmitters, the control function of the cluster head can become very complex. This is true at least for the reason that the cluster head has to perform at least the following functions:
allocate resources properly to avoid simultaneous transmission and reception at one device;
allocate resources properly to avoid long RTT delay for each transmitter's HARQ process;
collect CQI feedback to aid the link adaptation for each transmitter's data traffic;
collect feedback for each transmission to determine whether retransmission is needed; and
determine the retransmission strategy.

For the receiving devices the cluster head needs to know at least which data transmissions are for it and which are not; where to detect the desired data/control transmission, and where to send the feedback information.

### SUMMARY

The foregoing and other problems are overcome, and other advantages are realized, by the use of the exemplary embodiments of this invention.

In a first aspect thereof the exemplary embodiments of this invention provide a method that comprises operating a first wireless communications device in a role as a cluster head in a device-to-device communication mode cluster; and autonomously transferring the role of the cluster head to a second wireless communications device in the device-to-device communication mode cluster. In this method only a wireless communications device that is operating in the role of the cluster head has authority to transmit new data to another wireless communications device in the device-to-device communication mode cluster.

In a second aspect thereof the exemplary embodiments of this invention provide a method that comprises operating a first wireless communications device in a role as a cluster head in a device-to-device communication mode cluster; and transmitting a scheduling grant from the wireless communications device that is operating in the role of the cluster head to another wireless communications device in the device-to-device communication mode cluster. In this method the scheduling grant authorizes the another wireless communications device to perform, during a subframe specified by first information in the scheduling grant, a retransmission of data that was received by the another wireless communications device during a subframe specified by second information in the scheduling grant.

In a further aspect thereof the exemplary embodiments of this invention provide an apparatus that comprises at least one processor and at least one memory including computer program code. The memory and computer program code are configured to, with the at least one processor, cause the apparatus when operating a first wireless communications device in a role as a cluster head in a device-to-device communication mode cluster; to autonomously transfer the role of the cluster head to a second wireless communications device in the device-to-device communication mode cluster, where only a wireless communications device that is operating in the role of the cluster head has authority to transmit new data to another wireless communications device in the device-to-device communication mode cluster.

In a further aspect thereof the exemplary embodiments of this invention provide an apparatus that comprises at least one processor and at least one memory including computer program code. The memory and computer program code are configured to, with the at least one processor, cause the apparatus when operating a first wireless communications device in a role as a cluster head in a device-to-device communication mode cluster; to transmit a scheduling grant from the wireless communications device that is operating in the role of the cluster head to another wireless communications device in the device-to-device communication mode cluster, where the scheduling grant authorizes the another wireless communications device to perform, during a subframe specified by first information in the scheduling grant, a retransmission of data that was received by the another wireless communications device during a subframe specified by second information in the scheduling grant.

The exemplary embodiments also pertain to an apparatus that comprises means for operating a first wireless communications device in a role as a cluster head in a device-to-device communication mode cluster, and means for autonomously transferring the role of the cluster head to a second wireless communications device in the device-to-device communication mode cluster. In the apparatus only a wireless communications device that is operating in the role of the cluster head has authority to transmit new data to another wireless communications device in the device-to-device communication mode cluster. Furthermore, autonomously transferring comprises one of transferring the authority to transmit data as well as all device-to-device communication mode cluster control functions to the second wireless communications device, or transferring the authority to transmit data to the second wireless communications device, while retaining device-to-device communication mode cluster control functions.

The exemplary embodiments also pertain to an apparatus that comprises means for operating a first wireless communications device in a role as a cluster head in a device-to-device communication mode cluster; and means for transmitting a scheduling grant from the wireless communications device that is operating in the role of the cluster head to another wireless communications device in the device-to-device communication mode cluster. The scheduling grant authorizes the another wireless communications device to perform, during a subframe specified by first information in the scheduling grant, a retransmission of data that was received by the another wireless communications device during a subframe specified by second information in the scheduling grant. In the apparatus the first information reschedules the another wireless communications device from a receive mode to a transmit mode only for the one subframe specified by the first information.

### BRIEF DESCRIPTION OF THE DRAWINGS

In the attached Drawing Figures:

FIG. 1 reproduces FIG. 4.1 of 3GPP TS 36.300, and shows the overall architecture of the EUTRAN system.

FIG. 2 shows a simplified block diagram of various electronic devices that are suitable for use in practicing the exemplary embodiments of this invention.

FIG. 3 presents an example of RTT time for a TDM data transmission in one cluster.

FIGS. 4a and 4b, collectively referred to as FIG. 4, show an embodiment where a current cluster head device can hand over all of the cluster control functions to a successor cluster head device, and an embodiment where the current cluster head device only hands over the right for data transmission and its corresponding scheduling to the successor cluster head device, while retaining all other cluster control functions, respectively.

FIG. 5 shows a non-limiting example of scheduled cooperating retransmission.

FIG. 6 is a logic flow diagram that illustrates the operation of a method, and a result of execution at a D2D device of computer program instructions embodied on a computer readable memory, in accordance with the exemplary embodiments of this invention.

FIG. 7 is a logic flow diagram that illustrates the operation of a method, and a result of execution at a D2D device of computer program instructions embodied on a computer readable memory, further in accordance with the exemplary embodiments of this invention.

### DETAILED DESCRIPTION

The exemplary embodiments of this invention provide improvements to the D2D cluster concept to reduce the implementation complexity and to enable efficient retransmission.

As was made evident above, the cluster concept can be used for the data transfer use case of D2D communication. In one cluster there can be multiple devices that need to transfer data to the same or different target receivers. However, the implementation of the D2D data transmission cluster use case requires that a number of problems be addressed and solved.

For example, a first problem relates to what technique to use to distinguish the desired data at the receiver side. In LTE cellular, for any given UE, there is only one desired transmitter (the own cell eNB). The data/control transmitted from the eNB is scrambled with the RNTI of the target UE which enables the UE to determine whether what it receives is the desired data/control information.

An extension of this concept would be to assign multiple RNTIs to one device if it has to receive from multiple transmitters. However, a problem that arises relates to the increased detection complexity since the device may need to detect multiple scheduling grants to know where to detect the desired data transmission.

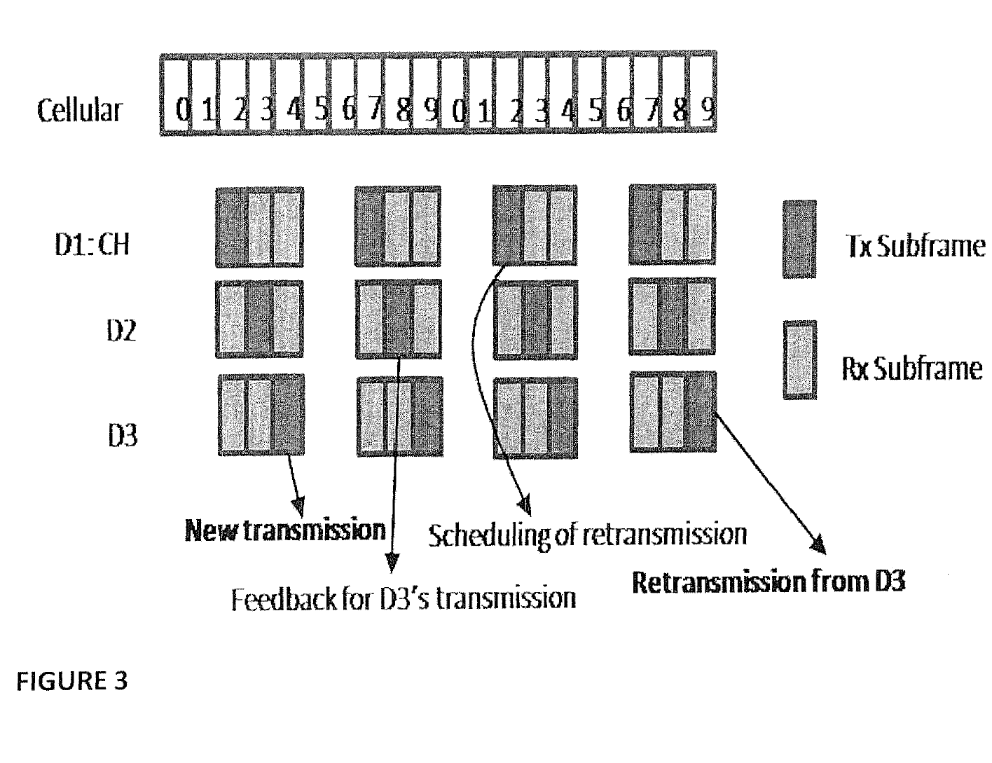

A second problem relates to what technique to use to properly allocate resources for different transmitters. In one cluster there can be multiple transmitters, and each of these multiple transmitters can also be a target receiver for one or more of the other transmitters. In this case FDM transmission for these transmitters is not possible since it will cause simultaneous transmission and reception. TDM transmission is one approach that might be used. However, the use of TDD can make the HARQ RTT very long, especially for a D2D deployment in TDD cellular. For example, if one assumes that the D2D terminals only use TDD UL subframes then there are at most three subframes available per 5 ms. If TDM is used by three transmitters, then there is one only transmission for each transmitter per 5 ms. In the non-limiting example of FIG. 3, the D2D transmissions occupy subframes 2,3,4 and 7,8,9 of the TDD cellular, and these subframes are allocated for data transmission from three devices, D1 D2 and D3. In this example D1 is assigned as the cluster head and controls the scheduling of all transmissions. As shown in FIG. 3 the RTT for the transmission of D3 is 15 ms, assuming that D3 makes a new transmission in subframe 4, receives the feedback from D2 in subframe 8, D1 schedules the retransmission for D3 in the next subframe 2, and D3 actually makes the retransmission in subframe 9.

In addition to the RTT issue, complex operation at the cluster side is another problem. For example, and still referring to FIG. 3, assume that all three devices have a data transmission. In this case the cluster head, i.e., D1 must perform the following in subframe 2:
based on feedback from D2 and D3 in subframe 8 and 9, determine whether its transmission in subframe 2 needs to be retransmitted;
based on feedback from D2 in subframe 8, determine whether the transmission from D3 in subframe 4 needs to be retransmitted and, if so, allocate resources for the transmission; and
based on feedback from D3 in subframe 9, determine whether the transmission from D2 in subframe 3 needs to be retransmitted and, if so, allocate resources for the transmission.

Clearly, this type of complex behavior is time (and power) consuming for the device functioning as the cluster head.

A further problem relates to what technique to use to enable efficient retransmission in a cluster. For example, assume a first case where one transmission has multiple target receivers and where some target receives detect the data correctly while others do not. In this case then the question arises as to how to best determine the retransmission parameters. The retransmission can performed by the original transmitter or/and one or more of the devices that have successfully detected the data. Reference in this regard may be made, for example, to Fen Hou, et al., A Cooperative Multicast Scheduling Scheme for Multimedia Services, IEEE 802.16 Networks, IEEE Trans. On Wireless Communications, Vol. 8, No. 3, March 2009.

It may be possible to provide automatic cooperative retransmission by both the transmitter and successful receivers where the successful receiver detects whether there is a NACK from other receivers and, if there is, it aids the retransmission automatically. However, this type of retransmission has the problem that it can only be a synchronized non-adaptive retransmission which can cause unnecessary power consumption and may also result in increased interference. In addition, there is a requirement that the successful receiver have advance knowledge of the feedback resources of the other receivers at least in order to detect the NACK transmitted by another one of the receivers.

Furthermore, if one device is to cooperate in the retransmission it may need to transmit in one subframe which has been assigned to be a reception subframe for that device according to the Tx/Rx configuration. Another possible case is that to aid in the retransmission the successful receiver may need a guard time in order to switch from Rx to Tx before retransmission or/and to switch from Tx to Rx after retransmission. Some mechanism would thus be required to handle this switching between operational states.

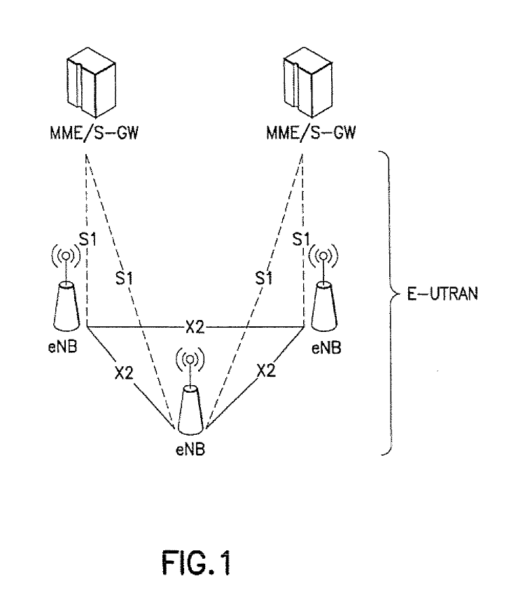

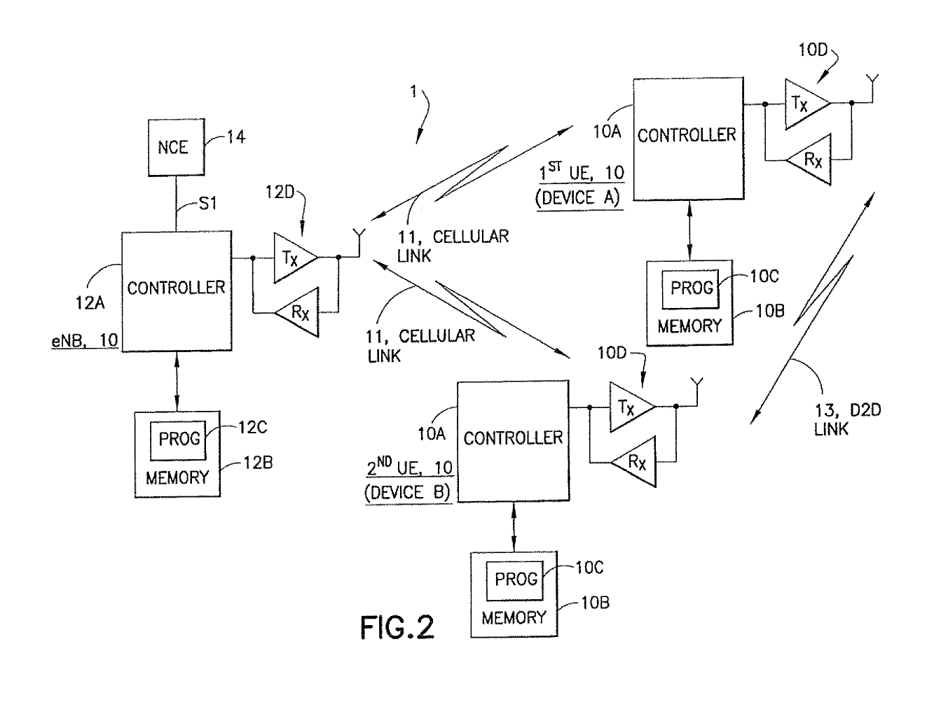

Before describing in detail the exemplary embodiments of this invention reference is made to FIG. 2 for illustrating a simplified block diagram of various electronic devices and apparatus that are suitable for use in practicing the exemplary embodiments of this invention. In FIG. 2 a wireless network 1, which may be a cellular wireless network, is adapted for communication over a wireless, e.g., cellular link 11 with an apparatus, such as a mobile communication device which may be referred to as a first UE 10, via a network access node, such as a Node B (base station), and more specifically an eNB 12. The cellular network 1 may include a network control element (NCE) 14 that may include the MME/SGW functionality shown in FIG. 1, and which can provide connectivity with a further network, such as a telephone network and/or a data communications network (e.g., the internet). The UE 10 includes a controller 10A, such as at least one computer or a data processor, at least one non-transitory computer-readable memory medium embodied as a memory 10B that stores a program of computer instructions (PROG) 10C, and at least one suitable radio frequency (RF) transmitter and receiver pair (transceiver) 10D for bidirectional wireless communications with the eNB 12 via one or more antennas. The eNB 12 also includes a controller 12A, such as at least one computer or a data processor, at least one computer-readable memory medium embodied as a memory 12B that stores a program of computer instructions (PROG) 12C, and at least one suitable RF transceiver 12D for communication with the UE 10 via one or more antennas (typically several when multiple input/multiple output (MIMO) operation is in use). The eNB 12 can be coupled via a data/control path to the NCE 14, where the path may be implemented as the S1 interface shown in FIG. 1. The eNB 12 may also be coupled to another eNB via the X2 interface shown in FIG. 1.

FIG. 2 shows the presence of a second UE 10 which may or may not be identically constructed as the first UE 10 (e.g., they may or may not be made by the same manufacturer). The transceivers 10D of the first and second UEs 10 are capable of wireless, direct communication via a D2D link 13. The first and second UEs 10 may thus be considered for the purposes of this description as being “D2D nodes” or “D2D terminals” or “D2D devices”, without a loss of generality. When in the D2D connection mode one of the D2D nodes can be considered to be a master D2D node, and the other(s) a slave D2D node. When in the D2D mode the first and second UEs 10, as well as other UEs, may form a D2D cluster. In this case one of the UEs 10 can be assigned the functionality of (the role of) the cluster head device. When operating in the D2D mode communication with the cellular system 1 via the eNB 12 can be accomplished at least by the D2D cluster head device.

It can be noted that in some use cases and deployments at least one of the D2D nodes can be a fixed (non-mobile) device/node. For example, one of the D2D nodes could function as a media content server capable of D2D communication with a population of mobile D2D nodes (UEs 10) in the vicinity of the fixed D2D node.

At least the program 10C is assumed to include program instructions that, when executed by the associated controller 10A, enable the device to operate in accordance with the exemplary embodiments of this invention, as will be discussed below in greater detail. That is, the exemplary embodiments of this invention may be implemented at least in part by computer software executable by the controller 10A of the UE 10 and/or by the controller 12A of the eNB 12, or by hardware, or by a combination of software and hardware (and firmware).

In general, the various embodiments of the UEs 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 10B and 12B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The controllers 10A and 12A may be of any type suitable to the local technical environment, and may include one or more of general purpose computers, special purpose computers, microprocessors, digital signal processors (DSPs) and processors based on multi-core processor architectures, as non-limiting examples.

The exemplary embodiments of this invention provide functionality, procedures and control signaling to enhance the operation of a D2D cluster. The use of the exemplary embodiments solves current and potential problems in D2D transmission in a cluster where there are multiple receivers and/or multiple transmitters. The use of the exemplary embodiments also reduces the implementation complexity at both the cluster head device and the slave devices (devices that are members of the cluster).

In a first exemplary aspect of this invention, and assuming a cluster with multiple transmitters, the transmitters are assigned one-by-one to have the role of the cluster head in a semi-static TDM manner. Only the currently assigned cluster head device is allowed to transmit new data to target receivers.

In one exemplary embodiment the cluster head switch from one transmitter to another transmitter in performed in a TDM manner, where the switching is configured by the eNB 12. The configuration can be sent to the devices (UEs 10) when the cluster is set up, together with other necessary control signaling. This guarantees that both the slave devices and the eNB 12 are aware of the cluster head to which to communicate with in a certain subframe. In this case the eNB 12, since it can signal the TDM switching pattern to the D2D cluster in advance, is preferably aware of the potential transmitters and their target receivers in the cluster in advance.

In another exemplary embodiment the cluster head switching from one device to another device is handled by the devices autonomously, and is not directly controlled by the eNB 12. That is, in this exemplary embodiment the role of the cluster head can be switched or transferred from one device to another device without direct control by the eNB 12, e.g., without the eNB 12 issuing an explicit switching command. When a device that is currently serving as the cluster head determines to switch the role of cluster head to another device (e.g., based on traffic needs of the current cluster head device or traffic needs of another device of the cluster, or based on some predetermined switching pattern or schedule received from the eNB 12) it can perform this function in an autonomous manner in accordance with several approaches.

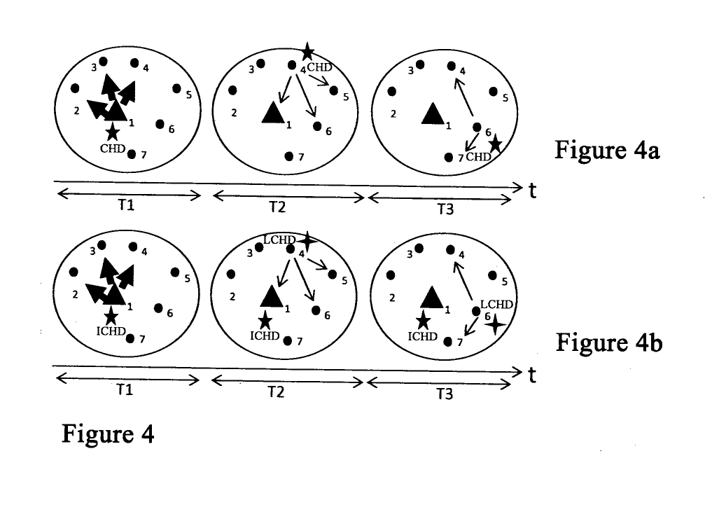

In a first approach, described below in relation to FIG. 4a, the current cluster head device can hand over all of the control functions to the successor cluster head device, and forward all cluster-related information to the successor cluster head device including, for example, the resource allocation and the identities of all existing devices in the cluster.

In a second approach, described below in relation to FIG. 4b, the current cluster head device only hands over the right for data transmission and its corresponding scheduling to the successor cluster head device, while retaining all other control functions in the initial cluster head. These other (retained) D2D control functions can include, for example, a function to broadcast to all devices the D2D-related control information obtained from the eNB 12, and a function to determine the Tx/Rx pattern for the devices of the D2D cluster.

With the first approach, and before switching, the current cluster head device can send signaling to the eNB 12 to inform the eNB 12 of the cluster head change. The eNB 12 can then subsequently send any D2D cluster-related control information to the new cluster head device, i.e., to the UE 10 that has most recently assumed the role of the cluster head.

With the second approach the eNB 12 need not be made aware of the cluster head change. The eNB 12 continues to send cluster-related control information to the initial cluster head device, and the initial cluster head device is responsible for informing the new cluster head device, and possibly all of the other cluster devices as well, of the control information received from the eNB 12. The use of this second approach has an advantage of guaranteeing good performance of broadcast control signaling since the eNB 12 can initially assign the original cluster head responsibility to a certain device which, for example, the eNB 12 knows via measurement signaling and feedback has good link quality with the most other devices in the cluster.

It should be noted that in the exemplary embodiment where the cluster head switching from one device to another device is handled by the devices autonomously, the switching can be based on a switching pattern received from the eNB 12. However the actual time at which the switching occurs can be decided within the cluster without participation by the eNB 12 in the actual decision to switch the role of the cluster head from a current cluster head device to another device. Alternatively, both the switching pattern and the time to actually switch the role of cluster head can be determined autonomously within the cluster by one or more devices within the cluster.

The use of the first exemplary aspect of the invention, where in both approaches described above only the cluster head is allowed to send new data to target receivers, reduces the RTT. This is true because the transmitter can send a scheduling grant, together with the data transmission, to a D2D cluster receiver, and the delay between scheduling and data transmission can be avoided. Another advantage is that same Tx/Rx pattern can be used for all the receivers, and the feedback from all of the receivers can be collected by the cluster head device in the same subframe. As there is feedback needed for only the single transmitter the detection at the transmitter/cluster head is simplified as compared with the other possibilities mentioned above.

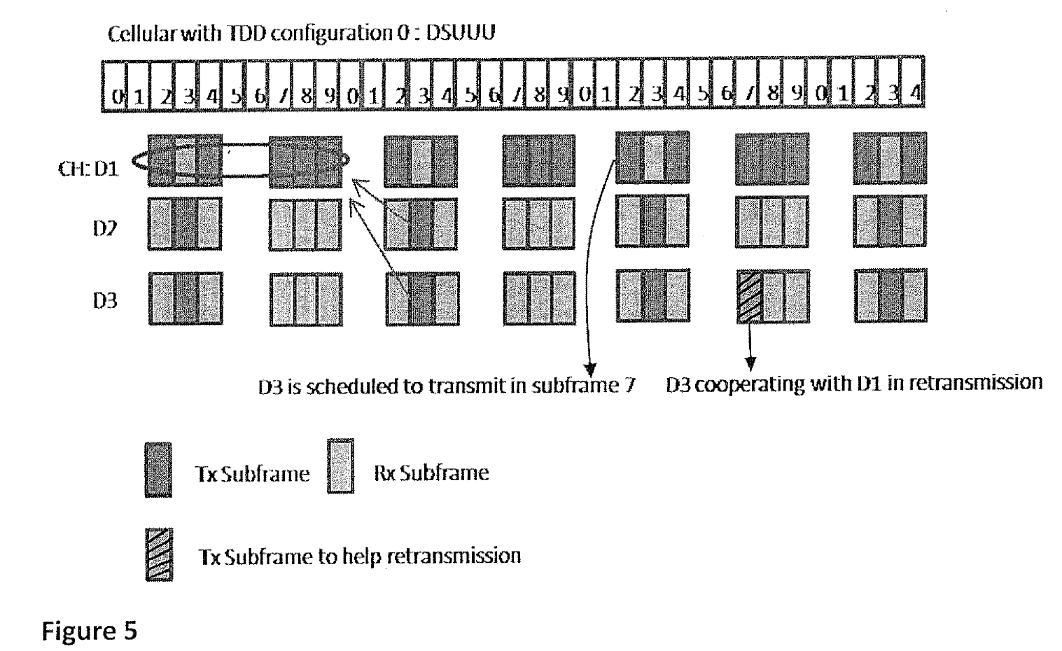

In a second exemplary aspect of this invention, described below in relation to FIG. 5, the cluster head can request a cooperative retransmission from a slave D2D device by sending a scheduling grant to one or multiple devices which have already successfully detected the previous data transmission. The scheduling grant can include at least the following three fields:
(a) one or more bits for indicating the subframe index in which the (re)transmission is to occur;
(b) one or more bits to indicate a HARQ process number to identify the data to be (re)transmitted; and
(c) one bit to indicate whether the transmission is made using a normal subframe length or a shortened subframe length.

After detecting a scheduling grant for its transmission in one subframe based on field (a) the slave device marks that subframe to be a Tx subframe, and overrides a previous Tx/Rx configuration for this device only for this subframe. That is, for any subframes not scheduled by the scheduling grant the previous Tx/Rx configuration is maintained. The slave device then transmits the data previously successfully received in the subframe indicated by field (b), i.e., by the HARQ process number. Based on the third field (c) the device knows the number of OFDM symbols the data transmission will occupy.

In general, and according to LTE specifications, for a normal CP (cyclic prefix) case there are 14 OFDM symbols, while for an extended CP case there are 12 OFDM symbols. The D2D devices can use the same or a different subframe structure as the overlying cellular system (e.g., LTE). Whether or not the D2D devices use the same subframe structure as the overlying system an aspect of the exemplary embodiments of this invention is to provide for a normal length and a shortened length subframe, where the shortened length subframe can be used to enable Tx/Rx or Rx/Tx switching. For the non-limiting case where the overlying system is a cellular LTE system, and if the D2D system uses the same subframe structure, the normal (non-shortened) subframe length can be 14 OFDM symbols for the normal CP case, and the shortened subframe length can be, for example, 13 OFDM symbols.

Section 5.3.3.1, “DCI formats”, more specifically subsection 5.3.3.1.1, “Format 0”, of 3GPP TS 36.212 V9.3.0 (2010-09) Technical Specification 3rd Generation Partnership Project; Technical Specification Group Radio Access Network; Evolved Universal Terrestrial Radio Access (E-UTRA); Multiplexing and channel coding (Release 9) specifies the current (Rel-9) LTE TDD UL grant. One element of DCI Format 0 is a 2-bit UL index for indicating which UL subframe is scheduled. However, in the field (a) defined above the index does not count only Tx subframes, instead it counts both the Tx and Rx subframes. This is so because the device may be required to perform the retransmission in a subframe which is actually defined to be an Rx subframe for the device according to the current Tx/Rx configuration. This approach thus enables the device to override a previous Tx/Rx configuration for the scheduled subframe and perform a retransmission during a subframe that was originally defined as a Rx subframe.

The field (c) can be used to provide a shortened subframe transmission, thus leaving unused one or more OFDM symbol for the Tx/Rx switching time when necessary. The field (c) is also useful in a scheduling grant for the data transmission from the cluster as this enables transmitting a shortened subframe and then leaving time for the Rx/Tx switching of a device.

Several non-limiting examples are now provided to aid in the understanding of the foregoing aspects of this invention.

### EXAMPLE 1

Referring to FIG. 4, assume there are seven devices in a cluster (e.g., seven of the UEs 10 shown in FIG. 2). Among these devices it is assumed that device 1 wants to transfer data to devices 2, 3 and 4; that device 4 wants to transfer data to devices 1, 5 and 6; and that device 6 wants to transfer data to devices 4 and 7.

FIG. 4a illustrates the operation of the first aspect of this invention discussed above, in particular the first approach wherein the current cluster head device hands over all of the control functions to the successor cluster head device. The data transmitters, i.e., the devices 1, 4 and 6 in this example, are assigned as cluster heads (marked by a star in figure, also referred to as a CHD) in a TDM manner. Device 1 is the cluster head device (CHD) during time T1, and transmits data to the target receivers during T1. Devices 4 and 6 then assume the role of the cluster head device during T2 and T3, respectively, and transmit during their respective time periods. That is, during T2 device 4 transmits to devices 1, 5 and 6, and during T3 device 6 transmits to devices 4 and 7. The durations of T1, T2 and T3 may be equal to one another, or they may be different.

The TDM pattern can be configured by the eNB 12 based on the SR (scheduling requests) from devices 1, 4 and 6 and broadcast to all devices in the cluster. Each device can be configured with a DRX pattern to facilitate power saving during those times when the device is not a target receiver. For example, during T2 of FIG. 4a the devices 2, 3 and 7 can enter a lower power consumption state, since they are not scheduled to receive data from device 4. During each of the time durations a device only needs to detect the SG (scheduling grant) and data transmission from one transmitter, i.e., from the cluster head device, thereby reducing the detection complexity. For the transmitter, since it is the cluster head and can autonomously schedule the data transmission, the RTT delay is reduced and the overall scheduling is simplified.

The durations of T1, T2 and T3 may be equal to one another, or they may be different. The durations may be configured by the eNB 12, also based on the SRs previously received. In general the time durations can be same or different depending on various factors, such as the buffer status, the traffic volume and/or the required service type of each transmitter.

The TDM pattern can also be determined by the devices themselves. In this case the eNB 12 initially configures one cluster head, e.g., device 1, and then the subsequent cluster head switching to other devices, e.g., device 4 and then device 6, is coordinated by the devices themselves without further control by the eNB 12. The present cluster head device can send signaling to inform the eNB 12 of the channel head change in advance using the reserved connectivity resource to the cellular network.

FIG. 4b also illustrates the operation of the first aspect of this invention discussed above, in particular the second approach wherein the current cluster head device only hands over the right for data transmission and its corresponding scheduling to the successor cluster head device, while retaining all other control functions originally granted to the initial cluster head. As in the example of FIG. 4a the cluster head switching is handled by device(s) themselves, but when switching the cluster head at least some control functionality is retained by the initial cluster head device, and only the right for data transmission and corresponding scheduling functions are handed over to new cluster head device. In FIG. 4b the initial cluster head device (ICHD) is marked with the star (device 1 in this example), while the later cluster head devices (4 and 6) are designated as LCHD. In this case there is no need to inform the eNB 12 of the change in the cluster head as the initial cluster head device (ICHD) is still responsible for maintaining at least some cluster-related communication with the eNB 12. The use of the approach of FIG. 4b results in reduced implementation complexity at both the cluster head device and the slave devices.

### EXAMPLE 2

Reference can be made to FIG. 5. Assume for this example that there are three devices (e.g., three UEs 10) in the cluster and that device 1 is assigned as the cluster head (CH). Assume as well that device 1 wants to transfer data to both device 2 and device 3. In this example the D2D communication only occupies the allocated resources in certain cellular UL subframes (subframes 2,3,4 and 7,8,9 in this example), and the cluster head device D1 configures the same RxTxRxRxRxRx pattern for both target receivers D2 and D3. In subframe 3, devices 2 and 3 feedback ACK/NACK for the data transmission in subframes 2, 4, 7, 8 and 9 as given by the scheduling grant from device 1 acting as the CH. In a case where, for example, device 3 feeds back an ACK for all the transmissions, but device 2 feeds back a NACK for at least some of the transmissions, then the cluster head device (D1) may request a cooperating retransmission from device 3. In this example the cluster head device sends a scheduling grant in subframe 2 to device 3 to schedule device 3 for retransmission in subframe 7.

According to the second exemplary aspect of this invention discussed above the subframe index in the scheduling grant is used to indicate to D3 that the retransmission will occur in subframe 7, and indicates for which HARQ process this is to occur (i.e., it indicates which subframe transmission was NACKed by device 2 and thus needs to be retransmitted by device 3).

Moreover, in subframe 7 device 3 needs to switch from the Tx mode to the Rx mode after making the retransmission. Thus, the cluster head device (D1) will also indicate in the scheduling grant that the transmission in subframe 7 will be in the shortened format to leave time for the required Tx/Rx switching for device 3. When detecting the scheduling grant for its transmission in subframe 7, device 3 will change the subframe 7 to a Tx subframe even though it is defined to be an Rx subframe according to the previously given Tx/Rx configuration. Any subframes not scheduled remain unchanged in accordance with the originally configured RxTxRxRxRxRx pattern.

It should be appreciated that the use of the exemplary embodiments of this invention provides significant enhancements for D2D operations, in particular for cluster head operations. The use of the exemplary embodiments enables reductions to be realized in scheduling and HARQ delay. In accordance with the first aspect of the invention only a data transmitter is assigned as a cluster head device, and thus only the cluster head device can send new data to other D2D devices. In accordance with the second aspect of the invention the change in the device having the role of the cluster head can be transparent to the network (to the eNB 12).

The exemplary embodiments of this invention further provide enhanced operations and signaling to facilitate cooperative retransmissions to ensure that the retransmission device has knowledge of the override of an originally allocated Tx/Rx pattern, as well as knowledge of the length of the retransmission subframe, thereby avoiding detection errors at the receiver side. Further, by providing a common understanding at both the cluster head and the cooperating retransmission device of the retransmission subframe(s) both transmitter and receiver errors can be avoided. The signaling to realize the Tx/Rx override can be achieved at least in part by adding one or more information fields to the scheduling grant and/or by interpreting the scheduling grant in a novel manner. This technique is advantageous in that it is dynamic and need be used only when necessary. The resulting Tx/Rx override is in force for the indicated subframe, and other subframes are not affected, and after the indicated subframe the retransmission device can revert to the original Tx/Rx subframe pattern.

In addition to providing the override indication, and to facilitate the cooperative retransmission, an indication of the subframe length can be included with the signaling so as to provide, if desired, an adequate Tx/Rx or Rx/Tx switching time for the device assisting in the cooperative retransmission.

It should be appreciated that the use of the exemplary embodiments provides a number of valuable technical effects and advantages. For example, one technical effect that arises from the use of the exemplary embodiments is that it enables multiple transmitters and multiple receivers to exist within a cluster with reduced complexity.

Another technical effect that is achieved is a reduction in HARQ RTT time for D2D transmission within a cluster.

Another technical effect that is achieved is an ability to provide implicit Tx/Rx switching signaling to enable efficient cooperative retransmission.

Based on the foregoing it should be apparent that the exemplary embodiments of this invention provide a method, apparatus and computer program(s) to enhance D2D communication mode operation when the D2D communication underlies a wireless communication network, such as a cellular network that can be, but is not limited to, an LTE-Advanced cellular network.

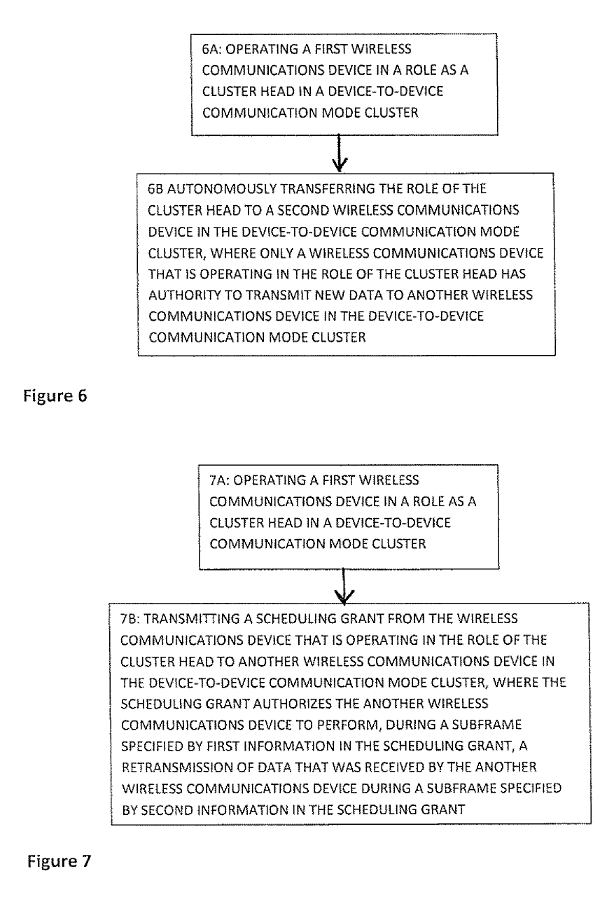

FIG. 6 is a logic flow diagram that illustrates the operation of a method, and a result of execution of computer program instructions, in accordance with the exemplary embodiments of this invention. In accordance with these exemplary embodiments a method performs, at Block 6A, a step of operating a first wireless communications device in a role as a cluster head in a device-to-device communication mode cluster; and autonomously transferring the role of the cluster head to a second wireless communications device in the device-to-device communication mode cluster, where only a wireless communications device that is operating in the role of the cluster head has authority to transmit new data (as opposed to retransmission data) to another wireless communications device in the device-to-device communication mode cluster.

The exemplary embodiments also encompass a non-transitory computer-readable medium that contains software program instructions, where execution of the software program instructions by at least one data processor results in performance of operations that comprise execution of the method of FIG. 6.

The various blocks shown in FIG. 6 may be viewed as method steps, and/or as operations that result from operation of computer program code, and/or as a plurality of coupled logic circuit elements constructed to carry out the associated function(s).

The exemplary embodiments also pertain to an apparatus that comprises at least one processor and at least one memory that includes computer program code. The memory and computer program code are configured to, with the at least one processor, cause the apparatus when operating a first wireless communications device in a role as a cluster head in a device-to-device communication mode cluster; to autonomously transfer the role of the cluster head to a second wireless communications device in the device-to-device communication mode cluster. Only a wireless communications device that is operating in the role of the cluster head has authority to transmit new data to another wireless communications device in the device-to-device communication mode cluster.

FIG. 7 is a logic flow diagram that illustrates the operation of a method, and a result of execution of computer program instructions, in accordance with the exemplary embodiments of this invention. In accordance with these exemplary embodiments a method performs, at Block 7A, a step of operating a first wireless communications device in a role as a cluster head in a device-to-device communication mode cluster; and transmitting a scheduling grant from the wireless communications device that is operating in the role of the cluster head to another wireless communications device in the device-to-device communication mode cluster, where the scheduling grant authorizes the another wireless communications device to perform, during a subframe specified by first information in the scheduling grant, a retransmission of data that was received by the another wireless communications device during a subframe specified by second information in the scheduling grant.

The exemplary embodiments of this invention also encompass a non-transitory computer-readable medium that contains software program instructions, where execution of the software program instructions by at least one data processor results in performance of operations that comprise execution of the method of FIG. 7.

The various blocks shown in FIG. 7 may also be viewed as method steps, and/or as operations that result from operation of computer program code, and/or as a plurality of coupled logic circuit elements constructed to carry out the associated function(s).

The exemplary embodiments also pertain to an apparatus that comprises at least one processor and at least one memory that includes computer program code. The memory and computer program code are configured to, with the at least one processor, cause the apparatus when operating a first wireless communications device in a role as a cluster head in a device-to-device communication mode cluster; to transmit a scheduling grant from the wireless communications device that is operating in the role of the cluster head to another wireless communications device in the device-to-device communication mode cluster. The scheduling grant authorizes the another wireless communications device to perform, during a subframe specified by first information in the scheduling grant, a retransmission of data that was received by the another wireless communications device during a subframe specified by second information in the scheduling grant.

The exemplary embodiments also pertain to an apparatus that comprises means for operating a first wireless communications device in a role as a cluster head in a device-to-device communication mode cluster, and means for autonomously transferring the role of the cluster head to a second wireless communications device in the device-to-device communication mode cluster. In the apparatus only a wireless communications device that is operating in the role of the cluster head has authority to transmit new data to another wireless communications device in the device-to-device communication mode cluster. Furthermore, autonomously transferring comprises one of transferring the authority to transmit data as well as all device-to-device communication mode cluster control functions to the second wireless communications device, or transferring the authority to transmit data to the second wireless communications device, while retaining device-to-device communication mode cluster control functions.

In the apparatus of the preceding paragraph, the authority to transmit data comprises authority to send scheduling information to other wireless communications devices in the device-to-device communication mode cluster, and the device-to-device communication mode cluster control functions comprise authority to transmit control information received from a base station to other wireless communications devices in the device-to-device communication mode cluster, and authority to determine a transmit/receive subframe pattern for other wireless communications devices in the device-to-device communication mode cluster.

The exemplary embodiments also pertain to an apparatus that comprises means for operating a first wireless communications device in a role as a cluster head in a device-to-device communication mode cluster; and means for transmitting a scheduling grant from the wireless communications device that is operating in the role of the cluster head to another wireless communications device in the device-to-device communication mode cluster. The scheduling grant authorizes the another wireless communications device to perform, during a subframe specified by first information in the scheduling grant, a retransmission of data that was received by the another wireless communications device during a subframe specified by second information in the scheduling grant. In the apparatus the first information reschedules the another wireless communications device from a receive mode to a transmit mode only for the one subframe specified by the first information.

The scheduling grant further comprises third information that specifies whether the retransmission from the another wireless communications device should use a normal or a shortened subframe length, where the third information indicates a number of orthogonal frequency division multiplex symbols to be used for the retransmission.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the overlay cellular network/system being a UTRAN LTE-A system, it should be appreciated that the exemplary embodiments of this invention are not limited for use with only this one particular type of wireless communication system, and that they may be used to advantage in other wireless communication systems. For example, the exemplary embodiments of this invention are not limited for use with only cellular-type radio communication networks, but may be used as well in non-cellular types of networks including, for example, wireless local area network (WLAN) deployments.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters, information elements and functional elements (e.g., “cluster head”, “device-to-device”, etc.) are not intended to be limiting in any respect, as these parameters, information elements and functional elements may be identified by any suitable names.

Furthermore, some of the features of the various non-limiting and exemplary embodiments of this invention may be used to advantage without the corresponding use of other features. For example, the embodiment of the method shown in FIG. 6 may be used without also using the embodiment of the method shown in FIG. 7, and vice versa. As such, the foregoing description should be considered as merely illustrative of the principles, teachings and exemplary embodiments of this invention, and not in limitation thereof.

1-54. (canceled)

55. An apparatus, comprising:
at least one processor; and
at least one memory that includes computer program code, where the memory and computer program code are configured to, with the at least one processor, cause the apparatus when operating a first wireless communications device in a role as a cluster head in a device-to-device communication mode cluster; to autonomously transfer the role of the cluster head to a second wireless communications device in the device-to-device communication mode cluster, where only a wireless communications device that is operating in the role of the cluster head has authority to transmit new data to another wireless communications device in the device-to-device communication mode cluster.

56. The apparatus as in claim 55, where autonomously transferring comprises transferring the authority to transmit data as well as all device-to-device communication mode cluster control functions to the second wireless communications device.

57. The apparatus as in claim 55, where autonomously transferring comprises transferring the authority to transmit data to the second wireless communications device, while retaining device-to-device communication mode cluster control functions.

58. The apparatus as in claim 56, where the authority to transmit data comprises authority to send scheduling information to other wireless communications devices in the device-to-device communication mode cluster.

59. The apparatus as in claim 56, where the device-to-device communication mode cluster control functions comprise authority to transmit control information received from a base station to other wireless communications devices in the device-to-device communication mode cluster, and authority to determine a transmit/receive subframe pattern for other wireless communications devices in the device-to-device communication mode cluster.

60. The apparatus as in claim 55, wherein said memory and said computer program code are further configured, with said at least one processor, to cause said apparatus to transmit a scheduling grant from the wireless communications device that is operating in the role of the cluster head to another wireless communications device in the device-to-device communication mode cluster, the scheduling grant authorizing the another wireless communications device to perform, during a subframe specified by first information in the scheduling grant, a retransmission of data that was received by the another wireless communications device during a subframe specified by second information in the scheduling grant.

61. The apparatus as in claim 60, where the first information reschedules the another wireless communications device from a receive mode to a transmit mode only for the one subframe specified by the first information.

62. The apparatus as in claim 60, where the scheduling grant comprises third information that specifies whether the retransmission from the another wireless communications device should use a normal or a shortened subframe length.

63. The apparatus as in claim 56, wherein said memory and said computer program code are further configured, with said at least one processor, to cause said apparatus to transmit signaling to a base station to inform the base station of the identity of the second wireless communications device to which the role of the cluster head has been autonomously transferred.

64. A method, comprising:
operating a first wireless communications device in a role as a cluster head in a device-to-device communication mode cluster; and
autonomously transferring the role of the cluster head to a second wireless communications device in the device-to-device communication mode cluster;
where only a wireless communications device that is operating in the role of the cluster head has authority to transmit new data to another wireless communications device in the device-to-device communication mode cluster.

65. An apparatus, comprising:
at least one processor; and
at least one memory that includes computer program code, where the memory and computer program code are configured to, with the at least one processor, cause the apparatus when operating a first wireless communications device in a role as a cluster head in a device-to-device communication mode cluster; to transmit a scheduling grant from the wireless communications device that is operating in the role of the cluster head to another wireless communications device in the device-to-device communication mode cluster, where the scheduling grant authorizes the another wireless communications device to perform, during a subframe specified by first information in the scheduling grant, a retransmission of data that was received by the another wireless communications device during a subframe specified by second information in the scheduling grant.

66. The apparatus as in claim 65, where the first information reschedules the another wireless communications device from a receive mode to a transmit mode only for the one subframe specified by the first information.

67. The apparatus as in claim 65, where the scheduling grant comprises third information that specifies whether the retransmission from the another wireless communications device should use a normal or a shortened subframe length.

68. The apparatus as in claim 65, wherein said memory and said computer program code are further configured, with said at least one processor, to cause said apparatus to autonomously transfer the role of the cluster head to a second wireless communications device in the device-to-device communication mode cluster, where only a wireless communications device that is operating in the role of the cluster head has authority to transmit new data to another wireless communications device in the device-to-device communication mode cluster.

69. The apparatus as in claim 68, where autonomously transferring comprises transferring the authority to transmit data as well as all device-to-device communication mode cluster control functions to the second wireless communications device.

70. The apparatus as in claim 68, where autonomously transferring comprises transferring the authority to transmit data to the second wireless communications device, while retaining device-to-device communication mode cluster control functions.

71. The apparatus as in claim 69, where the authority to transmit data comprises authority to send scheduling information to other wireless communications devices in the device-to-device communication mode cluster.

72. The apparatus as in claim 69, where the device-to-device communication mode cluster control functions comprise authority to transmit control information received from a base station to other wireless communications devices in the device-to-device communication mode cluster, and authority to determine a transmit/receive subframe pattern for other wireless communications devices in the device-to-device communication mode cluster.

73. The method as in claim 69, wherein said memory and said computer program code are further configured, with said at least one processor, to cause said apparatus to transmit signaling to a base station to inform the base station of the identity of the second wireless communications device to which the role of the cluster head has been autonomously transferred.

74. A method, comprising:
operating a first wireless communications device in a role as a cluster head in a device-to-device communication mode cluster; and
transmitting a scheduling grant from the wireless communications device that is operating in the role of the cluster head to another wireless communications device in the device-to-device communication mode cluster, the scheduling grant authorizing the another wireless communications device to perform, during a subframe specified by first information in the scheduling grant, a retransmission of data that was received by the another wireless communications device during a subframe specified by second information in the scheduling grant.
